(19) United States
(12) Patent Application Publication
(10) Pub. No.: US 2014/0282207 A1
(43) Pub. Date: Sep. 18, 2014

(54) INTEGRATION FOR APPLICATIONS AND CONTAINERS

(71) Applicants: Rita H. Wouhaybi, Portland, OR (US); Aras Bilgen, Hillsboro, OR (US); Jim S. Baca, Corrales, NM (US); Mark Price, Placitas, NM (US); Margaret E. Morris, Portland, OR (US); David I. Shaw, Portland, OR (US)

(72) Inventors: Rita H. Wouhaybi, Portland, OR (US); Aras Bilgen, Hillsboro, OR (US); Jim S. Baca, Corrales, NM (US); Mark Price, Placitas, NM (US); Margaret E. Morris, Portland, OR (US); David I. Shaw, Portland, OR (US)

(21) Appl. No.: 13/839,031

(22) Filed: Mar. 15, 2013

(51) Int. Cl. G06F 3/0484

(52) U.S. Cl. CPC G06F 3/0484
USPC 715/779

(57) ABSTRACT

A computing device for combining one or more containers of one or more applications is provided that includes a processor, a memory, and a dashboard module configured to access a first application that includes a plurality of first containers, access a second application that includes a plurality of second containers, and generate a dashboard based, at least in part, on the first application and the second application. A container mapping module can also be provided and configured to map a particular one of the plurality of first containers to a first functionality, and map a particular one of the plurality of second containers to a second functionality. The dashboard can include the particular one of the plurality of first containers and the particular one of the plurality of second containers, where the dashboard is provided at an assigned display location of the computing device.

### TECHNICAL FIELD

This disclosure relates in general to the field of computing devices and, more particularly, to integrating selected applications and containers in computing environments.

### BACKGROUND

End users have more media and communications choices than ever before. A number of prominent technological trends are currently afoot (e.g., more computing devices, more applications, more online video services, more customizable features), and these trends are changing the media landscape. In regards to mobility, companies such as Apple, Inc. (along with its mobile product lines (e.g., iPhone™, iPad™, iPod™, etc.) have successfully executed on the application model. As a natural consequence, operating systems (e.g., Microsoft Windows 8/Metro™) have changed to comply with this explosive application model.

One shortcoming of the application model involves the inability of applications to coexist concurrently on the mobile screen (i.e., the display of the computing device). This shortcoming inhibits the ability of the end user to multitask. Stated in different terminology, in current mobile contexts, when an end user launches an application, the application will occupy the entire real estate of the mobile device screen. In order to switch to another application, the end user is forced to toggle back to the home screen to select a separate application, or to use another gesture in order to retrieve to the list of applications running in the background, and subsequently launch another application, which would then appear in the screen foreground. Once the new application is launched, the previous application is removed from the screen and the newly selected application, once again, occupies the entire real estate of the mobile device screen.

These application management activities are cumbersome. This desire to access different types of information simultaneously (e.g., users being interested in different pieces of information that originate in different applications) cannot be resolved by existing mobile platforms.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for providing a framework for integrating applications and containers in accordance with one embodiment of the present disclosure;

FIG. 2 is a simplified schematic diagram illustrating one possible example for a dashboard configuration;

FIGS. 3A-3B are simplified block diagrams illustrating potential sharing activities that involve mobile devices in accordance with one embodiment of the present disclosure;

FIG. 4 is a simplified flowchart illustrating possible activities associated with the present disclosure;

FIG. 5 is a simplified block diagram illustrating an example architecture associated with a mobile device;

FIG. 6 is a simplified block diagram associated with an example ARM ecosystem system on chip (SOC) of the present disclosure; and

FIG. 7 is a simplified block diagram illustrating example logic that may be used to execute activities associated with the present disclosure.

### DETAILED DESCRIPTION OF EMBODIMENTS

### Overview

A computing device for combining one or more containers of one or more applications is provided that can include a processor, a memory, and a dashboard module that is configured to access a first application that includes a plurality of first containers, access a second application that includes a plurality of second containers, and generate a dashboard based, at least in part, on the first application and the second application. A container mapping module can also be provided and configured to map a particular one of the plurality of first containers to a first functionality, and map a particular one of the plurality of second containers to a second functionality. The dashboard can include the particular one of the plurality of first containers and the particular one of the plurality of second containers, where the dashboard is provided at an assigned (i.e., designated) display location of the computing device.

In more specific embodiments, the computing device can include a screen real estate selection module configured to receive instructions associated with the assigned display location of the dashboard and to assign one or more display boundaries for the dashboard. The computing device is configured to access and edit the dashboard. The computing device can be configured to use a network connection to publish the dashboard to a remote location. The computing device can also be configured to share the dashboard with at least one other computing device. In certain cases, the computing device is configured to extract a one line container from the first application and combine it with a one line container from the second application. The dashboard module can also be configured to prompt an end user of the computing device to download a missing application as part of adopting an additional dashboard that was received. In addition, the dashboard module can be configured to receive a subsequent dashboard to be used as a template to create an additional dashboard. Additionally, the dashboard module is configured to generate an additional dashboard to be distributed to a distribution list involving one or more employees. The additional dashboard can be marked as read-only such that it cannot be edited by a receiver of the additional dashboard. The additional dashboard can be distributed to the one or more employees based on their job title.

One or more embodiments can tie the potential advantageous effect(s) to embodiment feature(s) that can provide such effect(s). For example, certain embodiments allow an end user to personalize their dashboard by using various containers of several different applications. In addition, certain embodiments can allow an end user to share, publish, edit, etc. their dashboard creation.

### EXAMPLE EMBODIMENTS

Turning to FIG. 1, FIG. 1 is a simplified block diagram of a communication system 10 configured for integrating applications and containers in accordance with one embodiment of the present disclosure. Communication system 10 may include an end user 12 and a plurality of applications 14, which may include a plurality of containers 18a-18c. End user 12 may interface with applications 14 using any suitable interface (e.g., wired, wireless, via a 3^{rd} party application store, etc.). In addition, FIG. 1 may include a container mapping functionality module 20, a screen real estate selection module 25, and a dashboard module 30: all of which are discussed below.

Before detailing some of the possible capabilities and features of the platform of FIG. 1, it is important to understand some of the operating system challenges encountered in the application model. The following foundational information may be viewed as a basis from which the present disclosure may be properly explained. Consider an example involving a simple social media application (e.g., Facebook™). If an end user opens the Facebook™ application, she can begin moving through pictures, news feeds, etc. While browsing, this particular user notices a comment by a friend about an upcoming event this weekend. As a result, the end user quickly launches her weather application in order to check the forecast for the weekend. While that weather application loads, the user begins multitasking by checking stock prices, reviewing work e-mail, etc. Once the weather application is fully functional, the end user reviews the information, and then returns to the Facebook application. During the workday, the user can continue to have all of these applications open, as she systematically maintains loose connections to these applications on a relatively regular basis.

Many operating systems (OSes such as Linux™, Windows™, etc.) have created the concept of a window that can be resized in order to allow users visibility into many applications concurrently. While this may work for some limited desktop scenarios, due to ever-decreasing screen sizes and interaction models, such a model does not work for mobile devices. An argument could be made that, in many cases, the end user does not need to have an entire application visible in order to reach the information she seeks to access. Stated in different terminology, the end user may only seek to access a certain strand, segment, or portion of application (e.g., the one-day weather forecast for a certain zip-code instead of the entire home page of the Weather Channel™ application).

Many operating systems such as Windows™ and Linux™ allow a user to set different windows next to each other in an attempt to create a view that allows for multitasking across multiple applications. However, no such paradigm exists for mobile OSes. In addition, while mobile OSes do allow certain applications to send notifications (e.g., short message service (SMS) notifications or push notifications) to the main screen and, possibly, share screen real estate, this sharing is transient and cannot be modified by the user. Hence, current applications today are siloed and, further, they are contained within a specific platform and/or device. This renders the applications inflexible in the context of a tailored experience for the user.

Moreover, in recent years, several mobile dashboard instantiations have also appeared. However, none of these solutions offers the end user an option to create their own application through composition, which affords the ability to create a tailored experience. In addition, existing dashboards fail to offer the ability to share these tailored experiences once they are created. Consider a scenario in which the user has developed multiple cooking applications and seeks to publish that back to application store, share it with friends, post it on social media sites, etc.

Other application strategies attempt to solve many of these problems by providing dockable taskbars. These mechanisms are part of a program that does not lend itself to any type of personalizing, tailoring, or application composition. The Android™ framework supports a certain degree of reusability through intents, but the intents are not exposed to the end user and they cannot be reused between applications. Certain other solutions offer tiles, which can be accompanied by burdensome notification systems. However, these solutions do not allow end users to carve out a piece of an application and, subsequent, use it as a tile for sharing that customized experience.

In accordance with the teachings of the present disclosure, the framework of FIG. 1 can allow for the creation of a dashboard that is more amenable to providing an enjoyable mobile device experience. In one particular implementation, the end user is empowered to create a personalized dashboard with a number of containers on their individual screen, where the dashboard can be readily edited, saved, shared, and systematically referred to during any suitable time interval (e.g., during their daily activities). One embodiment of the present disclosure can allow for the customization of mobile screens based on an ad hoc integration (i.e., a blending, an amalgamation, or a mash-up) of any number of containers from different applications. The container integration allows the end user to personalize their own mobile experience, as further detailed below. These containers could also be set to change based on context, in the form of location, time of day, time of week and other parameters.

Consider the example of FIG. 1 in which end user 12 has access to a plurality of applications on his mobile device. End user 12 can be presented with a framework for dividing applications 14 into individual containers 18a-18c. This general activity is labeled #1 in FIG. 1. Subsequently, container mapping functionality module 20 can be used to take these containers and map them to different functionalities. This general activity is indicated at #2. At #3, screen real estate selection module 25 can be employed during the mapping activities. Hence, as developers create their applications, they are presented with a framework that can divide their applications into containers, which are mapped to different functionalities and to the real estate of the mobile device screen. End user 12 can then create a dashboard with any number of suitable containers on their screen, where the dashboard can be edited, published to any suitable location, saved, shared with other users, and/or referred to at any appropriate time. This general activity is indicated at #4 of FIG. 1.

In one particular embodiment, an Android Intent can provide a facility for performing a late runtime binding between the code in different applications. One significant use case can relate to the launching of activities, where the intent can be thought of as the glue between activities. In one particular example, the intent operates a passive data structure: holding an abstract description of an action to be performed. One aspect of the present disclosure deals with enhancing the user experience; however, an important ancillary aspect deals with providing a developer with the framework to enable the enhanced experience. The enhanced experience allows a developer to create a component with visual elements and underlying capabilities. The developer could also define the interactions between components. From the perspective of the end user, it allows them to select (e.g., a la carte) and share these components(s) between multiple computing devices and/or applications.

Consider an example in which a user seeks to watch a video using the YouTube™ application, while at the same time following Facebook™ updates, stock prices, and the weather. The end user can pull the one-liner container from one application on their mobile device and add it to the YouTube™ application. The result is an edited, fully customizable dashboard of different applications and application containers. The user can also save their dashboard such that they can reuse it, share it with other devices and users, etc.

Turning to FIG. 2, FIG. 2 illustrates one example dashboard illustrated generally by an arrow 35. It should be noted that the actual segments of the containers do not have to be horizontal. Indeed, segments of the containers could be vertical, could be provided in a distinct shape (e.g., a rectangle, circle, triangle, etc.) on the screen, could be provided at the edges of the mobile device, at a bottom tray of the mobile device, at a top row of the mobile device, etc. In the particular example of FIG. 2, the plurality of segments is illustrated at general arrows 40, 42, 44, 46, 48, and 50. These particular segments are associated with applications such as YouTube™, Yahoo's Stock Quotes™, Twitter™, a Weather Channel™ application, an iTunes™ application, a Gmail™ account application, etc.

Turning to FIG. 3A, FIG. 3A is a simplified block diagram illustrating an example of sharing activity generally indicated at an arrow 65. This particular scenario involves two iPhones™. A first user has developed a number of cooking applications 70. Those applications can reflect an amalgamation of multiple containers, segments of applications, etc. The framework of the present disclosure allows the first user to share or publish cooking applications 70 at any appropriate time. In the particular example of FIG. 3A, the first user has leveraged a wireless connection to send cooking applications 70 to a peer device. Additionally, the first user has elected to publish cooking applications 70 to an application store (e.g., iTunes™). FIG. 3B is a simplified schematic diagram that illustrates a similar example involving sharing activities 75 for a tailored application between two iPads™.

In operation, dashboard sharing is readily achieved by the present disclosure. It should be noted that the dashboard can be simply a placeholder with pieces that are assigned to existing applications. This could be shared by any communication mechanism (e.g., SMS, email, Bluetooth™, flash drive, memory stick, etc.). Once a dashboard is shared, it can automatically verify if the user has the appropriate applications to utilize the dashboard. If this is not the case, the shared dashboard can prompt the user to download the missing application(s), or alternatively modify that portion of the screen. The latter case would mean that they have used the original dashboard as, at least, a starting template to create their own custom dashboard.

In one particular scenario involving a corporate entity, a corporation could create their own dashboard and distribute it to their employees in order to provide a stream of information that the employees could follow (e.g., to relay compliance issues, work reports, deliverables, emergency notifications, business targets, etc.). In this particular enterprise example, management could package the applications with the dashboard and make them appear as a single, uninterrupted application (i.e., invisible as separate applications). This means that the applications would not appear as separate applications from which the employee can choose. In certain cases, the author of the dashboard could also mark the dashboard composition as read-only such that employees are prohibited from editing the dashboard. The use of a single enterprise dashboard provides uniformity and consistency for the corporation. Additionally, the dashboard creates one focal application, for example, with different views that can be managed separately. The role/level/job responsibilities of the employee can dictate which part(s) of the application is in their respective container. In one particular example, a distribution list is maintained for specific dashboards, applications, and/or containers for specific individuals.

In terms of dashboard recommendations, the present disclosure can provide a suitable dashboard recommendation based on modeling the end user's behavior. For example, the dashboard recommendation module can reside in the background of the mobile device, where it would learn of the interests of the user based on the number of applications starting and/or, the sequence of applications being executed during a day. The dashboard recommendations module could then propose a dashboard or a set of dashboards to the user. These recommendations could also take other contextual input as triggers to these dashboards (e.g., such as GPS/location to determine that a user is leaving work and they are more likely now to be interested in Pandora™/Traffic Applications/a Google Latitude™ Dashboard). If the mobile device were equipped with more sophisticated sensors (e.g., eye-gaze tracking, etc.), then this could be used to determine which part of the screen the user views, the length of the interaction, the frequency in order to determine its relative importance, etc.

In one particular example, the dashboard recommender is also a significant component for when the application is upgraded with a newer version that could potentially have an impact on the dashboard (i.e., the mash-up or amalgamation. This could be due to the fact the container in a dashboard has now changed considerably and, further, it now warrants different provisioning (e.g., using more space/less space/different conditions, etc.). In other scenarios, the dashboard recommender can be used when the container is coming from an application that does not support containers. When the application is upgraded, the recommender can compare the graphical user interface (GUI) of the previous version with the new one in order to determine whether the change was subtle (e.g., with a negligible effect on the GUI), or substantially affecting the dashboard. If the modification is relatively complex such that the recommendation module cannot create a suitable equivalent (e.g., automatically), the system can prompt the user for input. In certain cases, the framework could also save a backup copy of the previous version in case the user elects to restore that version in order to maintain a favorite dashboard.

As one possible extension to this framework, a developer can sell/offer some of their containers to other developers to use in their applications. In contrast to current models of code reuse, this would allow the developer to control the experience because they can be delivering the entire module (including the GUI), rather than a background application program interface (API) or a service in current mobile OS models. Yet another possible extension to this disclosure involves sharing a part of the dashboard such as a slideshow of user photos that can be streamed to any device. This could occur across devices even when the photos only reside on one of the owner's devices on the network.

FIG. 4 is a simplified flowchart illustrating example activities 100 associated with creating a dashboard in accordance with the teachings of the present disclosure. Intuitively, a dashboard is a collection of many containers. A container can be an entire application, a segment(s) of the application, a visual piece of the application, a modified summary representation, etc. The flow of this particular example may begin at 102 in which the user initiates the creation of a dashboard. This could be a special menu under applications, an application itself, or provisioned in any other suitable manner, etc. At 104, the user is presented with their applications that are divided into categories (e.g., two categories). The first category includes applications that have containers. For these applications, a list of the predefined containers is listed, and the user can then proceed to choose which container(s) they would like to add to their dashboard. The second category includes applications that do not support containers. For these applications, the user can select the application, and then suitably mark (e.g., with a gesture) the container boundary.

Subsequently, once the containers are selected, the user can decide to create either a static dashboard by suitably combining these containers (e.g., using drag/drop activities, along with gestures and subsequently realigning the boundaries to a suitable degree), or a dynamic dashboard. This is generally indicated at 106. In certain cases, the user can also assign more than one container to the same screen part. This would allow them to set conditions and thresholds for swapping the containers for particular dynamic models (i.e., changing or updating applications). For example, one piece of the screen could be shared among these containers with the corresponding conditions:
a. A calendar container if an appointment is starting in 15 minutes;
b. An email container if a message just arrived in the Inbox from one of a set of users; and
c. A stock container if the price change is more than 5% for the day.

At 108, the user can save the dashboard, provide a naming convention for it, share the dashboard, publish the dashboard, sell the dashboard in an application store, etc.

FIG. 5 is a simplified schematic diagram of a mobile device generally indicated at 85. More specifically, FIG. 5 illustrates a modified architecture diagram associated with an operating system of the mobile device. A number of applications are provided in this particular example (e.g., a dashboard work 86). In addition, an application framework is also illustrated that includes a dashboard manager 87. In addition, a number of libraries are illustrated, along with a runtime module and a Linux™ kernel.

In one potential implementation, a given mobile device OS architecture is changed in order to accommodate the features of the present disclosure. For example, the modified architecture of FIG. 5 can be reflective of an Android™ architecture that includes modules such as dashboard manager 87, dashboard work 86, etc. Dashboard manager 87 can be provisioned at the application framework level since it can interact with other modules in the application framework (e.g., such as the Window Manager™ and Package Manager). In operation, dashboard manager 87 can be responsible for saving, maintaining, and/or sharing containers. In alternative embodiments, dashboard manager 87 may include one or more dashboard recommender modules. Dashboard work 86 can be utilized by a developer to assist in creating one or more customized applications from one or more containers.

From the perspective of a developer, the present disclosure is offering a tool to assist a developer in dividing their application(s) into components that can be separated from the original main application. For example, this activity can be executed through a WYSIWYG™ tool. The WYSIWYG™ editor is a system in which content (e.g., text and graphics) displayed onscreen during editing can appear in a form closely corresponding to its appearance when ultimately displayed as a finished product. In addition, this could involve a development application (e.g., Eclipse™) to be used to drop a container into a GUI. Once the developer performs these operations, the tool can generate code in support of the idea of containing the relevant code.

An example of the code generation can include creating a content provider if the Android™ framework were the development platform. The advantage of containing the code is that after the user composes a dashboard, that piece of the application (related to the container) should be alive in memory and, therefore, only that piece of the application would be consuming resources. Even though intents in the Android™ framework are similar to this concept, they are not exposed to the end user. Teachings of the present disclosure would allow components to be exposed to the end user and, subsequently, mapped to visual screen containers.

Note that in such dashboard activities, if creating such code containment is not possible either because of the way the application is written or because the user is interested in creating a container that the developer did not envision, then the mobile OS can circumvent this issue by having the entire application running in the background, while pretending that it is alive in the foreground. In addition, the mobile OS can then only show one piece of that application and, further, add an opaque area over the pieces that should not be visible, and layer multiple screens accordingly. Additionally, it should be noted that most mobile OSes (including the Android™ framework) leave applications running in the background when a user moves back to the home screen. However, the application at that time typically has no visual components and, further, uses less memory, although the process continues to run unless the device is running out of memory. For this reason, one potential implementation is based on the notion of presuming that such applications are alive concurrently. In other implementations, the OS can allow an application to update at least a few of its graphical components, and then selectively in order to have those present to the user in support of the container experience.

Turning to the example infrastructure associated with the present disclosure, the term ‘end user’ is used interchangeably with ‘client devices’ and ‘computing devices’ and these terms are inclusive of any type of computer that can execute an application. This would include any type of receiver, a computer, a set-top box, an Internet radio device (IRD), a cell phone, a smart phone, a tablet, a personal digital assistant (PDA), a Google Android™, an iPhone™, an iPad™, a Microsoft Surface™, Google Nexus™, or any other device, component, element, endpoint, or object capable of initiating voice, audio, video, media, or data exchanges within communication system 10. Such devices may also be inclusive of a suitable interface to the human user, such as a display, a keyboard, a touchpad, a remote control, or any other terminal equipment. Such computing devices may also be any device that seeks to initiate a communication on behalf of another entity or element, such as a program, a database, or any other component, device, element, or object capable of initiating an exchange within communication system 10. Data, as used herein in this document, refers to any type of numeric, voice, video, media, audio, or script data, or any type of source or object code, or any other suitable information in any appropriate format that may be communicated from one point to another.

In general terms, the client devices can facilitate the application activities discussed herein. These client devices may include any suitable hardware, software, components, modules, interfaces, or objects that facilitate the operations thereof. This may be inclusive of appropriate algorithms and communication protocols that allow for the effective exchange of data or information. In one implementation, the client device includes software to achieve (or to foster) the application activities discussed herein. Additionally, each of these client devices can have an internal structure (e.g., a processor, a memory element, etc.) to facilitate some of the operations described herein. In other embodiments, these application activities may be executed externally to these devices (e.g., in the cloud, in the application store, etc.), or included in some other computing device to achieve the intended functionality. Alternatively, the client devices may include software (or reciprocating software) that can coordinate with other computing devices in order to achieve the application activities described herein. In still other embodiments, one or several devices may include any suitable algorithms, hardware, software, components, modules, interfaces, or objects that facilitate the operations thereof.

In one example, each respective client device can include software to achieve the application operations, as outlined herein in this document. In certain example implementations, the application functions outlined herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by a processor, or other similar machine, etc.). In some of these instances, a memory element can store data used for the operations described herein. This includes the memory element being able to store instructions (e.g., software, code, etc.) that are executed to carry out the activities described in this Specification. The processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the computing devices, etc.) can include memory elements for storing information to be used in achieving the application activities, as outlined herein. Additionally, each of these devices may include a processor that can execute software or an algorithm to perform the application activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the computing devices can also include suitable interfaces for receiving, transmitting, and/or otherwise communicating data or information in a network environment.

FIG. 6 is a simplified block diagram associated with an example ARM ecosystem SOC 600 of the present disclosure. At least one example implementation of the present disclosure includes an integration of the power savings features discussed herein and an ARM component. For example, the example of FIG. 6 can be associated with any ARM core (e.g., A-9, A-15, etc.). Further, the architecture can be part of any type of tablet, smartphone (inclusive of Android™ phones, i-Phones™), i-Pad™, Google Nexus™, Microsoft Surface™, personal computer, server, video processing components, laptop computer (inclusive of any type of notebook), Ultrabook™, any type of touch-enabled input device, etc.

In this example of FIG. 6, ARM ecosystem SOC 600 may include multiple cores 606-607, an L2 cache control 608, a bus interface unit 609, an L2 cache 610, a graphics processing unit (GPU) 615, an interconnect 602, a video codec 620, and a liquid crystal display (LCD) I/F 625, which may be associated with mobile industry processor interface (MIPI)/high-definition multimedia interface (HDMI) links that couple to an LCD.

ARM ecosystem SOC 600 may also include a subscriber identity module (SIM) I/F 630, a boot read-only memory (ROM) 635, a synchronous dynamic random access memory (SDRAM) controller 640, a flash controller 645, a serial peripheral interface (SPI) master or USB host controller 650, a suitable power control 655, a dynamic RAM (DRAM) 660, and flash 665. In addition, one or more embodiments include one or more communication capabilities, interfaces, and features such as instances of Bluetooth 670, a 3G modem 675, a global positioning system (GPS) 680, and an 802.11 WiFi 785.

In operation, the example of FIG. 6 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX™, Linux™, Microsoft Windows Embedded™, Symbian™ and Ubuntu™, etc.). In at least one embodiment, the core processor may implement an out-of-order superscalar pipeline with a coupled low-latency level-2 cache.

FIG. 7 is a simplified block diagram illustrating potential electronics and logic that may be associated with any of the power saving operations discussed herein. In at least one example, system 700 includes a touch controller 702, one or more processors 704, system control logic 706 coupled to at least one of processor(s) 704, system memory 708 coupled to system control logic 706, non-volatile memory and/or storage device(s) 710 coupled to system control logic 706, display controller 712 coupled to system control logic 706, display controller 712 coupled to a display, power management controller 718 coupled to system control logic 706, and/or communication interfaces 716 coupled to system control logic 706.

System control logic 706, in at least one embodiment, includes any suitable interface controllers to provide for any suitable interface to at least one processor 704 and/or to any suitable device or component in communication with system control logic 706. System control logic 706, in at least one example, includes one or more memory controllers to provide an interface to system memory 708. System memory 708 may be used to load and store data and/or instructions, for example, for system 700. System memory 708, in at least one example, includes any suitable volatile memory, such as suitable dynamic random access memory (DRAM) for example. System control logic 706, in at least one example, includes one or more I/O controllers to provide an interface to a display device, touch controller 702, and non-volatile memory and/or storage device(s) 710.

Non-volatile memory and/or storage device(s) 710 may be used to store data and/or instructions, for example within software 728. Non-volatile memory and/or storage device(s) 710 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 718 may include power management logic 730 configured to control various power management and/or power saving functions disclosed herein or any part thereof. In at least one embodiment, power management controller 718 is configured to reduce the power consumption of components or devices of system 700 that may either be operated at reduced power or turned off when the electronic device is in a closed configuration. For example, in at least one embodiment, when the electronic device is in a closed configuration, power management controller 718 performs one or more of the following: power down the unused portion of the display and/or any backlight associated therewith; allow one or more of processor(s) 704 to go to a lower power state if less computing power is required in the closed configuration; and shutdown any devices and/or components, such as a keyboard, that are unused when an electronic device is in the closed configuration.

Communications interface(s) 720 may provide an interface for system 700 to communicate over one or more networks and/or with any other suitable device. Communications interface(s) 720 may include any suitable hardware and/or firmware. Communications interface(s) 720, in at least one example, may include, for example, a network adapter, a wireless network adapter, a telephone modem, and/or a wireless modem.

System control logic 706, in at least one embodiment, includes one or more I/O controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one example, at least one processor 704 may be packaged together with logic for one or more controllers of system control logic 706. In at least one example, at least one processor 704 may be packaged together with logic for one or more controllers of system control logic 706 to form a System in Package (SiP). In at least one example, at least one processor 704 may be integrated on the same die with logic for one or more controllers of system control logic 706. For at least one embodiment, at least one processor 704 may be integrated on the same die with logic for one or more controllers of system control logic 706 to form a System on Chip (SoC).

For touch control, touch controller 702 may include touch sensor interface circuitry 722 and touch control logic 724. Touch sensor interface circuitry 722 may be coupled to detect touch input over a first touch surface layer and a second touch surface layer of a display (i.e., display device 710). Touch sensor interface circuitry 722 may include any suitable circuitry that may depend, for example, at least in part on the touch-sensitive technology used for a touch input device. Touch sensor interface circuitry 722, in one embodiment, may support any suitable multi-touch technology. Touch sensor interface circuitry 722, in at least one embodiment, includes any suitable circuitry to convert analog signals corresponding to a first touch surface layer and a second surface layer into any suitable digital touch input data. Suitable digital touch input data for one embodiment may include, for example, touch location or coordinate data.

Touch control logic 724 may be coupled to help control touch sensor interface circuitry 722 in any suitable manner to detect touch input over a first touch surface layer and a second touch surface layer. Touch control logic 724 for at least one embodiment may also be coupled to output in any suitable manner digital touch input data corresponding to touch input detected by touch sensor interface circuitry 722. Touch control logic 724 may be implemented using any suitable logic, including any suitable hardware, firmware, and/or software logic (e.g., non-transitory tangible media), that may depend, for example, at least in part on the circuitry used for touch sensor interface circuitry 722. Touch control logic 724 for one embodiment may support any suitable multi-touch technology.

Touch control logic 724 may be coupled to output digital touch input data to system control logic 706 and/or at least one processor 704 for processing. At least one processor 704 for one embodiment may execute any suitable software to process digital touch input data output from touch control logic 724. Suitable software may include, for example, any suitable driver software and/or any suitable application software. As illustrated in FIG. 7, system memory 708 may store suitable software 726 and/or non-volatile memory and/or storage device(s).

Note that with the examples provided above, as well as numerous other examples provided herein, interaction may be described in terms of layers, protocols, interfaces, spaces, and environments more generally. However, this has been done for purposes of clarity and example only. In certain cases, it may be easier to describe one or more of the functionalities of a given set of flows by only referencing a limited number of components. It should be appreciated that the architectures discussed herein (and its teachings) are readily scalable and can accommodate a large number of components, as well as more complicated/sophisticated arrangements and configurations. Accordingly, the examples provided should not limit the scope or inhibit the broad teachings of the present disclosure, as potentially applied to a myriad of other architectures.

It is also important to note that the blocks in the flow diagrams illustrate only some of the possible signaling scenarios and patterns that may be executed by, or within, the circuits discussed herein. Some of these blocks may be deleted or removed where appropriate, or these operations may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the present disclosure in that any suitable arrangements, chronologies, configurations, and timing mechanisms may be provided without departing from the teachings provided herein.

It is also imperative to note that all of the Specifications, protocols, and relationships outlined herein (e.g., specific commands, timing intervals, supporting ancillary components, application specifics, etc.) have only been offered for purposes of example and teaching only. Each of these data may be varied considerably without departing from the spirit of the present disclosure, or the scope of the appended claims. The specifications apply to many varying and non-limiting examples and, accordingly, they should be construed as such. In the foregoing description, embodiments have been described. Various modifications and changes may be made to such embodiments without departing from the scope of the appended claims. The description and drawings are, accordingly, to be regarded in an illustrative rather than a restrictive sense.

Additionally, it should be noted that with the examples provided above, interaction may be described in terms of two, three, or four computing devices. However, this has been done for purposes of clarity and example only. In certain cases, it may be easier to describe one or more of the functionalities of a given set of flows by only referencing a limited number of computing devices. It should be appreciated that communication system 10 (and its techniques) are readily scalable and, further, can accommodate a large number of components, as well as more complicated/sophisticated arrangements and configurations. Accordingly, the examples provided should not limit the scope or inhibit the broad techniques of communication system 10, as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

### EXAMPLE IMPLEMENTATIONS

Note that all optional features of the apparatus described above may also be implemented with respect to the method or process described herein and specifics in the examples may be used anywhere in one or more embodiments.

Example A1 can include a computing device, such as a smartphone, a mobile device of any kind, a notebook computer, a laptop, etc., which includes a circuit board coupled to a plurality of electronic components (which may include any type of hardware, elements, circuitry, etc.). The computing device can be used for combining one or more containers of one or more applications. The computing device can include a processor, a memory, and a dashboard module that is configured to access a first application that includes a plurality of first containers, access a second application that includes a plurality of second containers, and generate a dashboard based, at least in part, on the first application and the second application. A container mapping module is also provided and is configured to map a particular one of the plurality of first containers to a first functionality, and map a particular one of the plurality of second containers to a second functionality. The dashboard can include the particular one of the plurality of first containers and the particular one of the plurality of second containers, where the dashboard is provided at an assigned display location of the computing device.

In Example A2, the computing device includes a screen real estate selection module configured to receive instructions associated with the assigned display location of the dashboard and to assign one or more display boundaries for the dashboard. In Example A3, the computing device is configured to access and edit the dashboard. In Example A4, the computing device is configured to use a network connection to publish the dashboard to a remote location. In Example A5, the computing device is configured to share the dashboard with at least one other computing device. In Example A6, the computing device is configured to extract a one line container from the first application and combine it with a one line container from the second application. In Example A7, the dashboard module is configured to prompt an end user of the computing device to download a missing application as part of adopting an additional dashboard that was received. In Example A8, the dashboard module is configured to receive a subsequent dashboard to be used as a template to create an additional dashboard. In Example A9, the dashboard module is configured to generate an additional dashboard to be distributed to a distribution list involving one or more employees. In Example A10, the additional dashboard is marked as read-only such that it cannot be edited by a receiver of the additional dashboard, and wherein the additional dashboard is distributed to the one or more employees based on their job title. In Example A11, the dashboard module is further configured to provide one or more dashboard recommendations based on a modeling of a behavior associated with an end user of the computing device. In Example A12, the behavior relates to a number of applications being started or sequenced during a given time interval. In Example A13, at least one of the dashboard recommendations is based, at least in part, on a contextual input associated with a selected one of a group of inputs, the group of inputs consisting of: a location of the computing device; a time of day input; calendar information input; a proximity to others input; an audio input; and a previous behavior input. In Example A14, at least one of the dashboard recommendations is based, at least in part, on one or more sensors that are used to determine which part of a display of the computing device being viewed by the end user. In Example A15, the computing device is configured to access a list of predefined containers to be added to the dashboard. In Example A16, an operating system of the computing device is configured to allow an entire application to run in a background of a display of the computing device while at least a portion of the entire application is provided in a foreground of the display.

In Example S1, a system is provided (that can include a computing device such as a smartphone, a mobile device of any kind, a notebook computer, a laptop, etc.,) that can include a circuit board coupled to a plurality of electronic components (which includes any type of hardware, elements, circuitry, etc.). The system can include means for accessing a first application that includes a plurality of first containers; means for accessing a second application that includes a plurality of second containers; means for mapping a particular one of the plurality of first containers to a first functionality; means for mapping a particular one of the plurality of second containers to a second functionality; and means for generating a dashboard based, at least in part, on the first application and the second application, wherein the dashboard includes the particular one of the plurality of first containers and the particular one of the plurality of second containers, and wherein the dashboard is provided at an assigned display location of a computing device. The ‘means for’ in these instances (above and below) can include (but is not limited to) using any suitable processor, software, circuitry, hub, computer code, logic, algorithms, hardware, controller, interface, link, bus, communication pathway, etc.

In Example S2, the subject matter of Example S1 can optionally include means for receiving instructions associated with the assigned display location of the dashboard and to assign one or more display boundaries for the dashboard. The system could also optionally include means for using a network connection to publish the dashboard to a remote location. The system could also optionally include means for sharing the dashboard with at least one other computing device. The system could also optionally include means for extracting a one line container from the first application and combining it with a one line container from the second application.

In Example CRM1, one or more non-transitory tangible media that includes code for execution and when executed by a processor can perform operations comprising: accessing a first application that includes a plurality of first containers; accessing a second application that includes a plurality of second containers; mapping a particular one of the plurality of first containers to a first functionality; mapping a particular one of the plurality of second containers to a second functionality; and generating a dashboard based, at least in part, on the first application and the second application, wherein the dashboard includes the particular one of the plurality of first containers and the particular one of the plurality of second containers, and wherein the dashboard is provided at an assigned display location of a computing device.

In Example CRM2, a system for combining one or more containers of one or more applications, comprising means for performing the method of any of the preceding claims. In Example, CRM3, the means for performing the method comprise a processor and a memory. In Example CRM4, the system in any one of the preceding claims, wherein the memory comprises machine-readable instructions that when executed cause the system to perform the method of any of the preceding claims. In Example CRM5, the system in any one of the preceding claims, wherein the system is a computing device. In Example CRM6, at least one computer readable medium comprising instructions that, when executed, implement a method or realize an apparatus as claimed in any of the preceding claims.

What is claimed is:

1. A computing device for combining one or more containers of one or more applications, comprising:
a processor;
a memory;
a dashboard module configured to:
access a first application that includes a plurality of first containers,
access a second application that includes a plurality of second containers,
generate a dashboard based, at least in part, on the first application and the second application;
a container mapping module configured to:
map a particular one of the plurality of first containers to a first functionality,
map a particular one of the plurality of second containers to a second functionality, wherein the dashboard includes the particular one of the plurality of first containers and the particular one of the plurality of second containers, and wherein the dashboard is provided at an assigned display location of the computing device.

2. The computing device of claim 1, further comprising:
a screen real estate selection module configured to receive instructions associated with the assigned display location of the dashboard and to assign one or more display boundaries for the dashboard.

3. The computing device of claim 1, wherein the computing device is configured to access and edit the dashboard.

4. The computing device of claim 1, wherein the computing device is configured to use a network connection to publish the dashboard to a remote location.

5. The computing device of claim 1, wherein the computing device is configured to share the dashboard with at least one other computing device.

6. The computing device of claim 1, wherein the computing device is configured to extract a one line container from the first application and combine it with a one line container from the second application.

7. The computing device of claim 1, wherein the dashboard module is configured to prompt an end user of the computing device to download a missing application as part of adopting an additional dashboard that was received.

8. The computing device of claim 1, wherein the dashboard module is configured to receive a subsequent dashboard to be used as a template to create an additional dashboard.

9. The computing device of claim 1, wherein the dashboard module is configured to generate an additional dashboard to be distributed to a distribution list involving one or more employees.

10. The computing device of claim 9, wherein the additional dashboard is marked as read-only such that it cannot be edited by a receiver of the additional dashboard, and wherein the additional dashboard is distributed to the one or more employees based on their job title.

11. The computing device of claim 1, wherein the dashboard module is further configured to provide one or more dashboard recommendations based on a modeling of a behavior associated with an end user of the computing device.

12. The computing device of claim 11, wherein the behavior relates to a number of applications being started or sequenced during a given time interval.

13. The computing device of claim 11, wherein at least one of the dashboard recommendations is based, at least in part, on a contextual input associated with a selected one of a group of inputs, the group of inputs consisting of:
a) a location of the computing device;
b) a time of day input;
c) calendar information input;
d) a proximity to others input;
e) an audio input; and
f) a previous behavior input.

14. The computing device of claim 11, wherein at least one of the dashboard recommendations is based, at least in part, on one or more sensors that are used to determine which part of a display of the computing device being viewed by the end user.

15. The computing device of claim 1, wherein the computing device is configured to access a list of predefined containers to be added to the dashboard.

16. The computing device of claim 1, wherein an operating system of the computing device is configured to allow an entire application to run in a background of a display of the computing device while at least a portion of the entire application is provided in a foreground of the display.

17. One or more non-transitory tangible media that includes code for execution and when executed by a processor operable to perform operations comprising:
accessing a first application that includes a plurality of first containers;
accessing a second application that includes a plurality of second containers;
mapping a particular one of the plurality of first containers to a first functionality;
mapping a particular one of the plurality of second containers to a second functionality; and
generating a dashboard based, at least in part, on the first application and the second application, wherein the dashboard includes the particular one of the plurality of first containers and the particular one of the plurality of second containers, and wherein the dashboard is provided at an assigned display location of a computing device.

18. The media of claim 17, the operations further comprising:
receiving instructions associated with the assigned display location of the dashboard and to assign one or more display boundaries for the dashboard.

19. The media of claim 17, the operations further comprising:
using a network connection to publish the dashboard to a remote location.

20. The media of claim 17, the operations further comprising:
sharing the dashboard with at least one other computing device.

21. The media of claim 17, the operations further comprising:
extracting a one line container from the first application and combining it with a one line container from the second application.

22. A system for combining one or more containers of one or more applications, comprising:
means for accessing a first application that includes a plurality of first containers;
means for accessing a second application that includes a plurality of second containers;
means for mapping a particular one of the plurality of first containers to a first functionality;
means for mapping a particular one of the plurality of second containers to a second functionality; and
means for generating a dashboard based, at least in part, on the first application and the second application, wherein the dashboard includes the particular one of the plurality of first containers and the particular one of the plurality of second containers, and wherein the dashboard is provided at an assigned display location of a computing device.

23. The system of claim 22, further comprising:
means for receiving instructions associated with the assigned display location of the dashboard and to assign one or more display boundaries for the dashboard.

24. The system of claim 22, further comprising:
means for using a network connection to publish the dashboard to a remote location.

25. The system of claim 22, further comprising:
means for sharing the dashboard with at least one other computing device.
